(19) United States
(12) Patent Application Publication
(10) Pub. No.: US 2026/0291145 A1
(43) Pub. Date: Sep. 24, 2026

(54) CONNECTOR

(71) Applicant: YAZAKI CORPORATION, Tokyo (JP)

(72) Inventors: Masaaki IWABE, Shizuoka (JP); Leonardo IWAZAKI, Shizuoka (JP)

(73) Assignee: YAZAKI CORPORATION, Tokyo (JP)

(21) Appl. No.: 19/556,399

(22) Filed: Mar. 4, 2026

(30) Foreign Application Priority Data
Mar. 19, 2025 (JP) 2025-044734

(51) Int. Cl. H01R 13/6593

(52) U.S. Cl. CPC H01R 13/6593; H01R 2201/26

(57) ABSTRACT

A connector includes a pair of electric wires, a pair of energizing terminals, a pair of ground terminals, a housing, and a conductive exterior member electrically connected to the ground terminals. The exterior member includes a first sheath portion disposed to cover a first ground terminal, a second sheath portion disposed to cover a second ground terminal, and a coupling portion disposed between the first and second ground terminals and connecting the first and second sheath portions. The first and second sheath portions include protrusion portions protruding toward the ground terminal. The coupling portion has a shape bent to protrude toward the ground terminals at a first connection portion between the coupling portion and the first sheath portion and at a second connection portion between the coupling portion and the second sheath portion, and the first and second connection portions are in contact with the pair of ground terminals, respectively.

### CROSS-REFERENCE TO RELATED APPLICATIONS

This application is based on and claims priority under 35 USC 119 from Japanese Patent Application No. 2025-044734 filed on Mar 19, 2025, the contents of which are incorporated herein by reference.

### TECHNICAL FIELD

The present disclosure relates to a connector.

### BACKGROUND ART

In the related art, a connector with a shielding function including a terminal accommodated in a housing, an electric wire connected to the terminal, and a metal shield shell attached to the outside of the housing has been proposed (for example, see Patent Literature 1).

### CITATION LIST

### Patent Literature

Patent Literature 1: JP2023-005221A

### SUMMARY OF INVENTION

In the shielded connector described above in the related art, a ground terminal for grounding a shield material such as a braid provided in an electric wire, is electrically connected to the shield shell. Here, for the purpose of enhancing the reliability of electrical connection between the ground terminal and the shield shell, it is conceivable to provide a protrusion or the like on the shield shell and press the protrusion or the like into contact with the ground terminal. However, when the shield shell is actually provided with the protrusion or the like, if the shield shell is molded by pressing, it may be difficult to mold the protrusion or the like into a designed shape around a portion in which a base material is particularly largely deformed during the pressing (for example, a portion in which the base material is deformed into a wedge shape to enter a gap between a pair of ground terminals) due to an increase in extension of the base material. The insufficient electrical connection between the ground terminal and the shield shell due to the inappropriate molding of the protrusion or the like may impair the shielding function of the connector.

One object of the present disclosure is to provide a connector with an excellent shielding function.

In order to achieve the above object, a connector according to the present disclosure is characterized by the following.

A connector includes a pair of electric wires each including a conductor core wire and a shield material covering the conductor core wire; a pair of energizing terminals electrically connected to the conductor core wires, respectively; a pair of ground terminals electrically connected to the shield materials, respectively; a housing in which the pair of energizing terminals are accommodated; and a conductive exterior member electrically connected to the pair of ground terminals. The exterior member includes a first sheath portion disposed to cover a first ground terminal of the pair of ground terminals, a second sheath portion disposed to cover a second ground terminal of the pair of ground terminals, and a coupling portion disposed between the first ground terminal and the second ground terminal and connecting the first sheath portion and the second sheath portion. The first sheath portion includes a protrusion portion protruding toward the first ground terminal and being in contact with the first ground terminal, and the second sheath portion includes a protrusion portion protruding toward the second ground terminal and being in contact with the second ground terminal. The coupling portion has a shape bent to protrude toward the pair of ground terminals at a first connection portion between the coupling portion and the first sheath portion and at a second connection portion between the coupling portion and the second sheath portion, and the first and second connection portions are in contact with the pair of ground terminals, respectively.

According to the connector of the present disclosure, the conductive exterior member (for example, an upper shell and a lower shell constituting the shield shell) electrically connected to the ground terminals includes the first sheath portion covering the first ground terminal, the second sheath portion covering the second ground terminal, and the coupling portion disposed between the first ground terminal and the second ground terminal and connecting the first sheath portion and the second sheath portion. Each of the first sheath portion and the second sheath portion includes the protrusion portion that protrudes toward the corresponding ground terminal and is in contact with the corresponding ground terminal. Further, the coupling portion has a shape bent to protrude toward the ground terminals at the connection portions with the first sheath portion and the second sheath portion, and the connection portions are in contact with the ground terminals, respectively. Since the protrusion portions and the connection portions are in contact with the ground terminals, respectively, the ground terminals and the exterior member are electrically connected. In other words, the first and second connection portions between the coupling portion and each of the first sheath portion and the second sheath portion have the same function as the protrusion portions for electrical connection. In addition, the coupling portion also has a function of regulating (that is, partitioning) the positions of the pair of ground terminals so that the ground terminals maintain an appropriate interval. Therefore, even when the exterior member is molded by the pressing, it is not necessary to extremely largely deform the base material of the exterior member to enter the gap between the pair of ground terminals in the wedge shape. Therefore, by connecting the first sheath portion and the second sheath portion via the coupling portion having such a shape, the protrusion portions provided on the first sheath portion and the second sheath portion are appropriately molded. Accordingly, the reliability of the electrical connection between the exterior member and the ground terminals is enhanced, and thus the shielding function of the connector is improved. Therefore, the connector according to the present disclosure is excellent in the shielding function.

The present disclosure has been briefly described above. Further, details of the present disclosure will be further clarified by reading modes for carrying out the invention described below with reference to the accompanying drawings.

### BRIEF DESCRIPTION OF DRAWINGS

FIG. 1 is a perspective view showing a connector according to an embodiment of the present disclosure;

FIG. 2 is an exploded perspective view of the connector shown in FIG. 1;

FIG. 3 is a perspective view of a portion A in FIG. 2 as viewed frontward and obliquely upward;

FIG. 4 is a perspective view of a second shield shell shown in FIG. 2 as viewed from rearward and obliquely upward;

FIG. 5 is a front view showing only electric wires and components related to the electric wires in a state of being accommodated in a housing shown in FIG. 2;

FIG. 6 is a front view of the connector shown in FIG. 1;

FIG. 7 is a cross-sectional view taken along a line B-B in FIG. 6; and

FIG. 8 is an enlarged view of a portion C in FIG. 7.

### DESCRIPTION OF EMBODIMENTS

### Embodiments

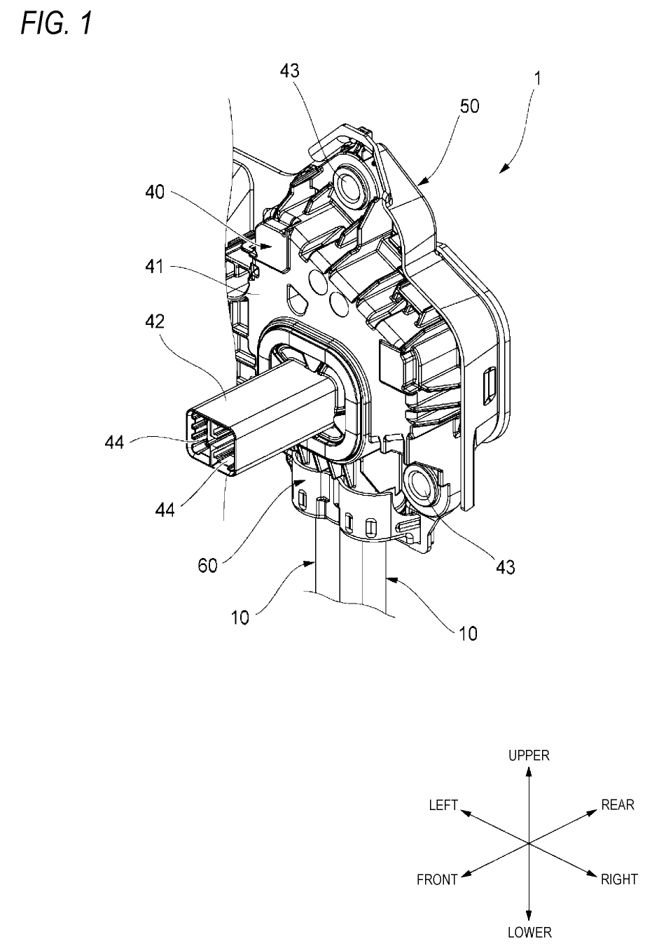

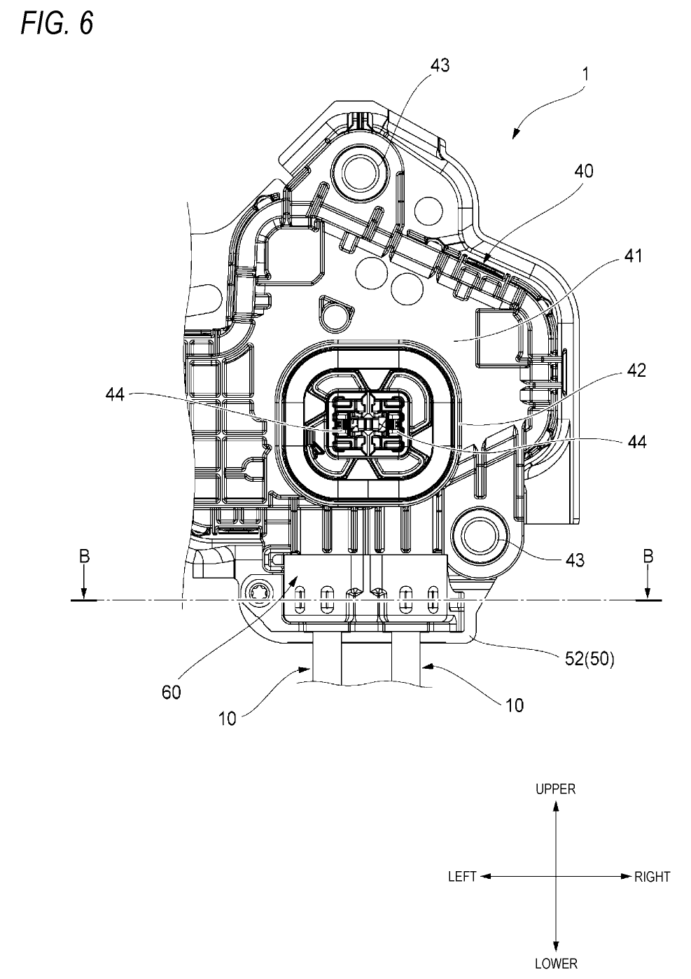

Hereinafter, a connector 1 according to an embodiment of the present disclosure will be described with reference to the drawings. The connector 1 shown in FIGS. 1 and 6 functions as a relay connector that electrically connects a pair of electric wires 10 extending from a body portion 41 of a housing 40 and a counterpart connector (not shown) fitted to a fitting portion 42 of the housing 40. The counterpart connector is, for example, an inverter (a DC-AC converter) mounted on a vehicle, and one end side of the pair of electric wires 10 extending from the body portion 41 of the housing 40 is connected to, for example, an air conditioner mounted on the vehicle.

Hereinafter, for convenience of description, "front", "rear", "upper", "lower", "left", "right", a "front-rear direction", an "upper-lower direction", and a "left-right direction" are defined as shown in FIG. 1 and the like. The "front-rear direction", the "upper-lower direction", and the "left-right direction" are orthogonal to one another. The front-rear direction coincides with a fitting direction of the connector 1 (the fitting portion 42 of the housing 40) and the counterpart connector. The upper-lower direction, the front-rear direction, and the left-right direction do not necessarily have to coincide with an upper-lower direction, a front-rear direction, and a left-right direction of the vehicle or the like on which the connector 1 is mounted.

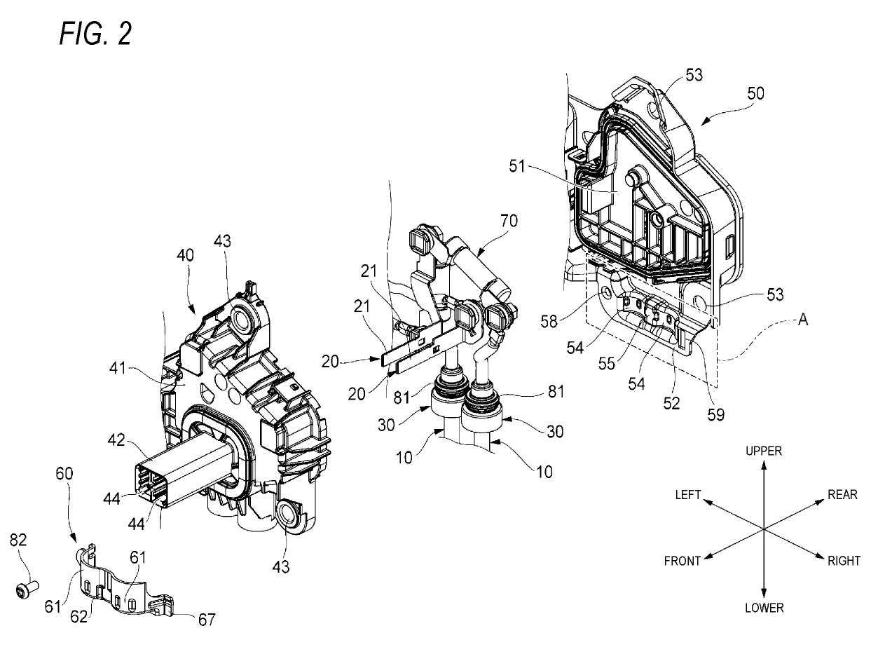

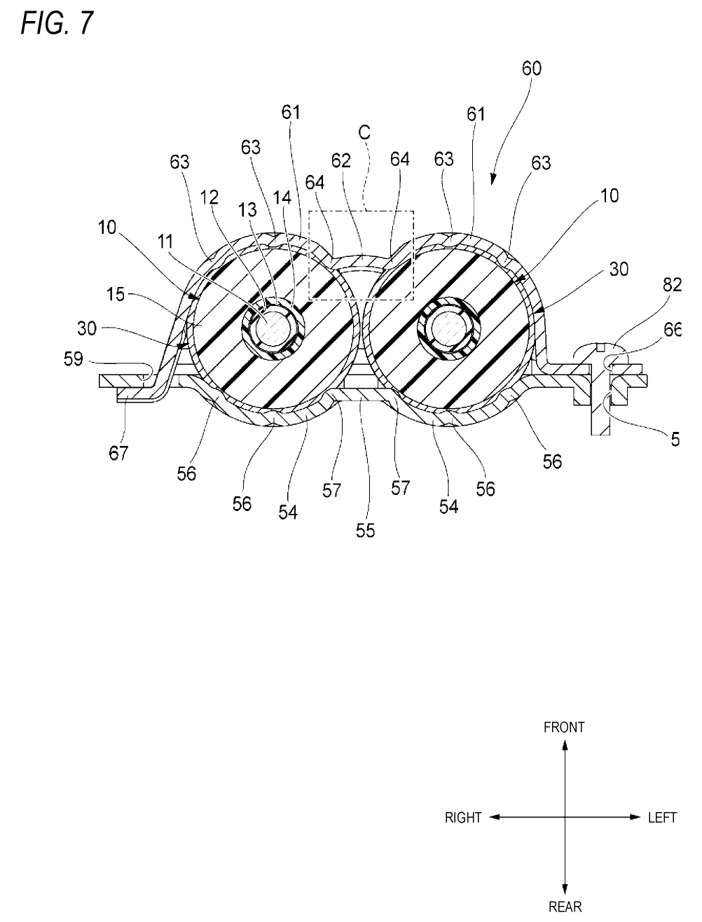

As shown in FIG. 2 and the like, the connector 1 includes the pair of electric wires 10, a pair of terminals 20 respectively electrically connected to conductor core wires 11 (see FIG. 7) of the pair of electric wires 10, a pair of shielded terminals 30 respectively electrically connected to braided conductors 13 (see FIG. 7) of the pair of electric wires 10, the housing 40 in which both the pair of terminals 20 are accommodated, and a first shield shell 50 and a second shield shell 60 that are electrically connected to both the pair of shielded terminals 30. Hereinafter, each component constituting the connector 1 will be described in order.

First, the electric wires 10, the terminals 20, and the shielded terminals 30 will be described. As shown in FIG. 7, each of the electric wires 10 includes the linear conductor core wire 11, a cylindrical inner insulating sheath 12 covering the outer periphery of the conductor core wire 11, the cylindrical braided conductor 13 covering the outer periphery of the inner insulating sheath 12, and a cylindrical outer insulating sheath 14 covering the outer periphery of the braided conductor 13. As shown in FIGS. 2, 5 and 7, a thick cylindrical support body (or a packing made of rubber) 15 made of resin is mounted on the outer periphery of a first portion of each electric wire 10 extending downward from the housing 40 (see FIG. 7), the first point is covered with a sheath portion 54 of the first shield shell 50 and a sheath portion 61 of the second shield shell 60 (see FIGS. 2 and 7), and the thin cylindrical shielded terminal 30 made of metal is mounted on the outer periphery of the support body 15. The shielded terminal 30 is electrically connected to the braided conductor 13 (not shown) pulled out from the electric wire 10 and folded back. A packing 81 is mounted on the outer periphery of a second portion adjacent to an upper side (a side opposite to an extending direction of the electric wire 10) of the first portion of the electric wire 10. The packing 81 is a sealing member made of rubber, and functions to seal an annular gap defined between the outer periphery of the electric wire 10 (more specifically, the outer insulating sheath 14) and each of the housing 40 and the first shield shell 50.

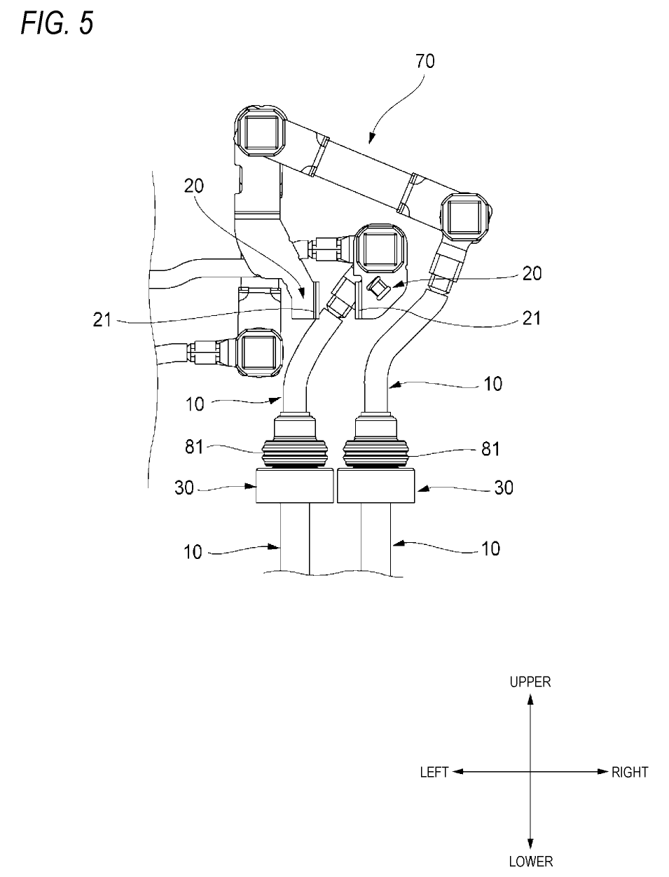

The other end side of the electric wires 10 is routed in an internal space of the body portion 41 of the housing 40 in the form shown in FIGS. 2 and 5. Of the pair of left and right electric wires 10 extending downward from the body portion 41 of the housing 40, the conductor core wire 11 on the other end side of the right electric wire 10 is electrically connected to, via a fuse 70, the left terminal 20 of the pair of left and right terminals 20 arranged side by side in the left-right direction in the internal space of the body portion 41, and the conductor core wire 11 on the other end side of the left electric wire 10 is electrically connected (conductively connected) to the right terminal 20 of the pair of left and right terminals 20 without the fuse 70.

Each of the pair of left and right terminals 20 is formed by performing pressing, bending, or the like on one metal plate, and includes a flat plate-shaped tab portion 21 extending in the front-rear direction as shown in FIGS. 2 and 5. The tab portions 21 of the pair of left and right terminals 20 are respectively accommodated in a pair of left and right terminal accommodating chambers 44 (see FIGS. 1, 2, and the like) in the housing 40, which will be described later.

Next, the housing 40 will be described. The housing 40 is a resin molded product and includes the body portion 41 and the fitting portion 42 as shown in FIG. 2. The body portion 41 has a box shape extending in the upper-lower direction, the left-right direction, and the front-rear direction and opening rearward. The fitting portion 42 is a substantially rectangular cylindrical portion protruding forward from a substantially central portion of a front end surface of the body portion 41, and is a portion to be fitted to the counterpart connector.

Fastening and fixing portions 43 are provided at a plurality of portions of an outer peripheral edge portion of the body portion 41. Each fastening and fixing portion 43 is a portion that is fastened to a fastening and fixing portion 53 (see FIG. 2) of the first shield shell 50, which will be described later. The pair of left and right terminal accommodating chambers 44 penetrating in the front-rear direction are formed in the fitting portion 42 to correspond to the pair of left and right terminals 20.

The pair of left and right terminals 20, the pair of left and right electric wires 10, the fuse 70, and the like are accommodated in the internal space of the body portion 41 of the housing 40 such that the tab portions 21 of the pair of left and right terminals 20 are respectively accommodated in the pair of left and right terminal accommodating chambers 44 of the fitting portion 42 from a rear side, and the pair of left and right electric wires 10 extend downward from the body portion 41 in a state in which the pair of left and right shielded terminals 30 protrude downward from a lower end edge of the body portion 41. When the connector 1 and the counterpart connector are fitted to each other, the pair of left and right terminals 20 (male terminals) accommodated in the fitting portion 42 (the terminal accommodating chambers 44) and a pair of left and right terminals (female terminals, not shown) of the counterpart connector are connected, respectively.

Next, the first shield shell 50 will be described. The first shield shell 50 is formed by performing the pressing, the bending, or the like on one metal plate, and integrally includes a substantially flat plate-shaped body portion 51 having a shape corresponding to the shape of a rear end opening of the body portion 41 of the housing 40, and an extending portion 52 extending further downward from a lower end portion of the body portion 51 and extending in the left-right direction, as shown in FIG. 2.

The body portion 51 is a portion that functions to be assembled to the body portion 41 to close the rear end opening of the body portion 41 of the housing 40. The body portion 51 is provided with the fastening and fixing portions 53 at a plurality of portions of an outer peripheral edge portion of the body portion 51 to correspond to the plurality of fastening and fixing portions 43 of the housing 40.

The extending portion 52 is a portion that extends to protrude downward from the body portion 41 of the housing 40 in a state in which the first shield shell 50 is mounted on the housing 40 (that is, in a state in which the body portion 51 covers the rear end opening of the body portion 41), and is a portion that functions to cover the rear outer peripheries of the pair of left and right shielded terminals 30 provided on the pair of left and right electric wires 10.

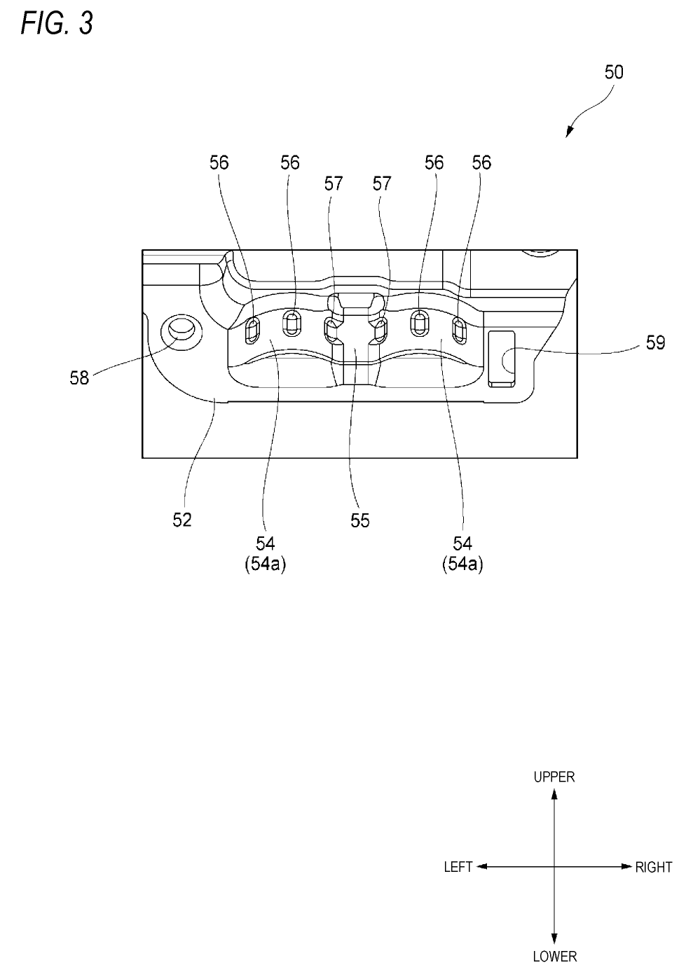

As shown in FIGS. 2 and 3, the extending portion 52 integrally includes the pair of left and right sheath portions 54 corresponding to the pair of left and right shielded terminals 30, and a coupling portion 55 positioned between the pair of left and right sheath portions 54 and connecting the sheath portions 54. Each of the pair of left and right sheath portions 54 is a portion disposed to cover the rear outer periphery of the corresponding one of the pair of left and right shielded terminals 30 provided on the pair of left and right electric wires 10, and the coupling portion 55 is a portion disposed between the pair of left and right shielded terminals 30.

As shown in FIG. 3, a concave curved surface 54a having a curved shape corresponding to an outer peripheral shape of the shielded terminal 30 is formed on a front surface side of each sheath portion 54. The concave curved surface 54a is formed with a plurality of (two in this example) protrusion portions 56 arranged at intervals in a circumferential direction thereof. In an assembled state of the connector 1 (see FIG. 1), each of the plurality of (four in total) protrusion portions 56 is in contact with a rear outer peripheral surface of the corresponding shielded terminal 30 (see FIG. 7).

As shown in FIG. 3, a protrusion portion 57 protruding toward the outer peripheral surface of the corresponding shielded terminal 30 is formed at each of a connection portion between the left sheath portion 54 and the coupling portion 55 and a connection portion between the right sheath portion 54 and the coupling portion 55. In the assembled state (see FIG. 1) of the connector 1, each of the pair of left and right protrusion portions 57 is also in contact with the rear outer peripheral surface of the corresponding shielded terminal 30 (see FIG. 7).

The coupling portion 55 connecting the pair of left and right sheath portions 54 has a flat shape extending in the left-right direction at a portion sandwiched between the pair of left and right protrusion portions 57 (also see FIG. 7). When the coupling portion 55 has a shape protruding forward (a shape protruding in a direction of entering a gap between the pair of left and right shielded terminals 30) at the portion sandwiched between the pair of left and right protrusion portions 57, it may be difficult to mold the protrusion portions 56 and 57 in a shape as designed because extension of a base material increases due to an increase in the degree of curvature at the portion. In this regard, in the present embodiment, since the portion of the coupling portion 55 has a flat shape, the excessive extension of the base material at the time of molding can be restrained, and the protrusion portions 56 and 57 are likely to be appropriately molded.

As shown in FIGS. 2 and 3, a bolt through hole 58 penetrating in a plate thickness direction (the front-rear direction) is formed in a left end portion (a portion on a left side of the left sheath portion 54) of the extending portion 52. A locking hole 59 penetrating in the plate thickness direction (the front-rear direction) is formed in a right end portion (a portion on a right side of the right sheath portion 54) of the extending portion 52. The bolt through hole 58 and the locking hole 59 are portions that function to fasten and fix the first shield shell 50 and the second shield shell 60 to each other (see FIG. 7).

The first shield shell 50 is assembled to the housing 40 from the rear side such that the body portion 51 closes the rear end opening of the body portion 41 of the housing 40 in a state in which the pair of left and right terminals 20, the pair of left and right electric wires 10, the fuse 70, and the like are accommodated in the body portion 41. Then, the fastening and fixing portions 43 of the housing 40 and the fastening and fixing portions 53 of the first shield shell 50, which are arranged to face each other, are fastened and fixed to each other using bolts (not shown). At this time, it is preferable to interpose a rubber packing (not shown) in an annular gap between the body portion 51 and an edge of the rear end opening of the body portion 41. Accordingly, the annular gap is sealed in a liquid-tight manner. In addition, the annular gap defined between the outer periphery of the corresponding electric wire 10 (more specifically, the outer insulating sheath 14) and each of the housing 40 and the first shield shell 50 is sealed in a liquid-tight manner by the corresponding one of the pair of left and right packings 81 (see FIGS. 2 and 5).

In a state in which the first shield shell 50 is assembled to the housing 40, the rear end opening of the body portion 41 of the housing 40 is closed by the body portion 51 of the first shield shell 50. The pair of left and right shielded terminals 30 provided on the pair of left and right electric wires 10 extending downward from the body portion 41 of the housing 40 are adjacently arranged in front of the extending portion 52 of the first shield shell 50 disposed to protrude downward from the body portion 41 of the housing 40, and the rear outer peripheral surface of each of the shielded terminals 30 is covered by the corresponding sheath portion 54 of the extending portion 52.

Next, the second shield shell 60 will be described. The second shield shell 60 is formed by performing the pressing, the bending, or the like on one metal plate, and is a component assembled to the extending portion 52 of the first shield shell 50 to sandwich the pair of left and right shielded terminals 30 in the front-rear direction with the extending portion 52 of the first shield shell 50.

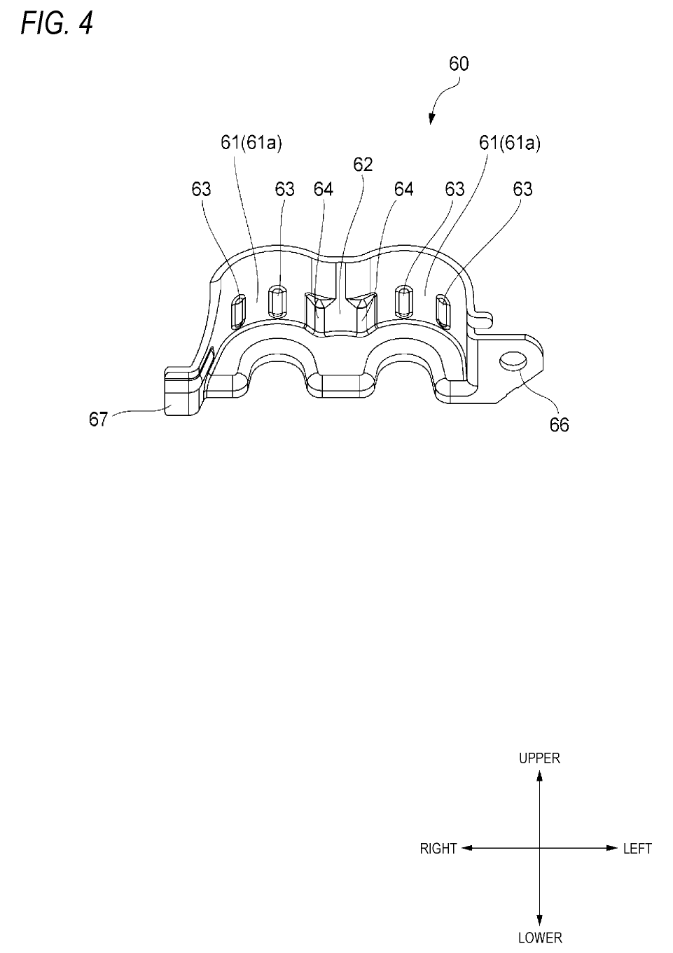

The second shield shell 60 has a shape extending in the left-right direction, and integrally includes the pair of left and right sheath portions 61 corresponding to the pair of left and right shielded terminals 30, and a coupling portion 62 positioned between the pair of left and right sheath portions 61 and coupling the sheath portions 61, as shown in FIGS. 2 and 4. Each of the pair of left and right sheath portions 61 is a portion disposed to cover the front outer periphery of the corresponding one of the pair of left and right shielded terminals 30 provided on the pair of left and right electric wires 10, and the coupling portion 62 is a portion disposed between the pair of left and right shielded terminals 30.

As shown in FIG. 4, a concave curved surface 61a having a curved shape corresponding to the outer peripheral shape of the shielded terminal 30 is formed on a rear surface side of each sheath portion 61. The concave curved surface 61a is formed with a plurality of (two in this example) protrusion portions 63 arranged at intervals in a circumferential direction thereof. In the assembled state of the connector 1 (see FIG. 1), each of the plurality of (four in total) protrusion portions 63 is in contact with a front outer peripheral surface of the corresponding shielded terminal 30 (see FIG. 7).

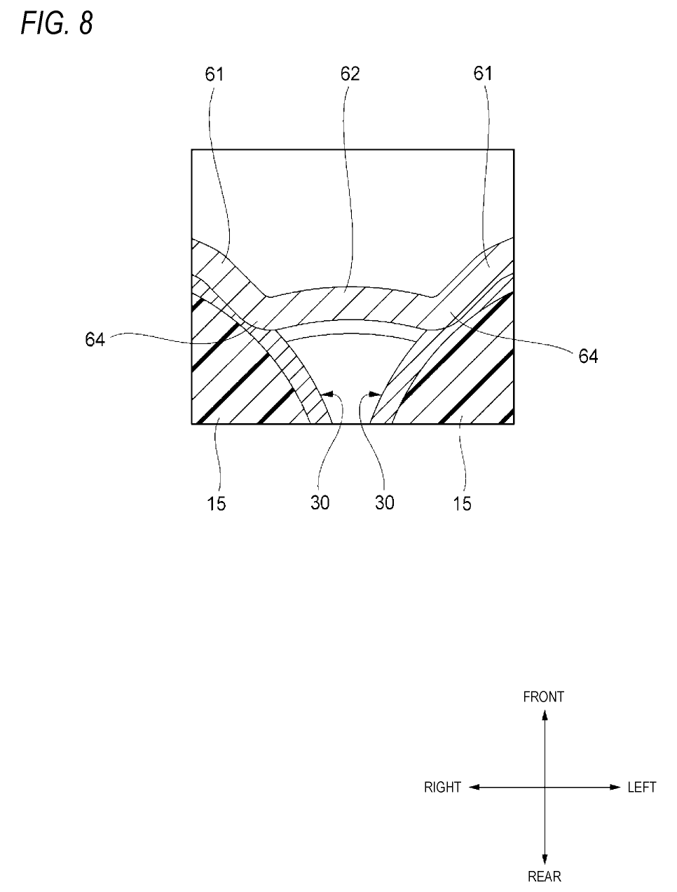

As shown in FIG. 4, a protrusion portion 64 protruding toward the outer peripheral surface of the corresponding shielded terminal 30 is formed at each of a connection portion between the left sheath portion 61 and the coupling portion 62 and a connection portion between the right sheath portion 61 and the coupling portion 62. In the assembled state (see FIG. 1) of the connector 1, each of the pair of left and right protrusion portions 64 is also in contact with the front outer peripheral surface of the corresponding shielded terminal 30 (see FIGS. 7 and 8).

The coupling portion 62 coupling the pair of left and right sheath portions 61 has a shape protruding forward (a shape protruding in a direction away from the gap between the pair of left and right shielded terminals 30) at a portion sandwiched between the pair of left and right protrusion portions 64 (see FIGS. 7 and 8). When the coupling portion 62 has a shape protruding rearward (a shape protruding in a direction of entering the gap between the pair of left and right shielded terminals 30) at the portion sandwiched between the pair of left and right protrusion portions 64, it may be difficult to mold the protrusion portions 63 and 64 in a shape as designed because extension of a base material increases due to an increase in the degree of curvature at the portion. In this regard, in the present embodiment, since the portion of the coupling portion 62 has a shape protruding forward, the excessive extension of the base material at the time of molding can be restrained, and the protrusion portions 63 and 64 are likely to be appropriately molded.

As shown in FIGS. 2 and 4, a bolt through hole 66 penetrating in the plate thickness direction (the front-rear direction) is formed in a left end portion (a portion on a left side of the left sheath portion 61) of the second shield shell 60. A locking piece 67 extending rightward is formed in a right end portion (a portion on a right side of the right sheath portion 61) of the second shield shell 60. The bolt through hole 66 and the locking piece 67 are portions that function to fasten and fix the first shield shell 50 and the second shield shell 60 to each other (see FIG. 7).

The second shield shell 60 is assembled to the extending portion 52 from a front side to sandwich the pair of left and right shielded terminals 30 in the front-rear direction with the extending portion 52 of the first shield shell 50 assembled to the housing 40. Specifically, in a state in which the second shield shell 60 is disposed to cover, from the front side, the pair of left and right shielded terminals 30 positioned in front of the extending portion 52 of the first shield shell 50, the locking piece 67 of the second shield shell 60 is locked to the locking hole 59 of the first shield shell 50, and the left end portions of the first and second shield shells 50 and 60 are fastened and fixed to each other by using a bolt 82 inserted into the bolt through hole 66 of the second shield shell 60 and the bolt through hole 58 of the first shield shell 50, whereby the second shield shell 60 is assembled to the extending portion 52 of the first shield shell 50 (see FIG. 7). The second shield shell 60 is not assembled (not fixed) to the housing 40. As described above, the assembly of the connector 1 is completed, and the connector 1 shown in FIG. 1 is obtained.

In the assembled state of the connector 1, as shown in FIGS. 7 and 8, the rear outer peripheries of the pair of left and right shielded terminals 30 are covered by the concave curved surfaces 54a of the pair of left and right sheath portions 54 of the first shield shell 50, the front outer peripheries of the pair of left and right shielded terminals 30 are covered by the concave curved surfaces 61a of the pair of left and right sheath portions 61 of the second shield shell 60, each of the plurality of protrusion portions 56 and 57 of the first shield shell 50 is in contact with the rear outer peripheral surface of the corresponding shielded terminal 30, and each of the plurality of protrusion portions 63 and 64 of the second shield shell 60 is in contact with the front outer peripheral surface of the corresponding shielded terminal 30. Accordingly, the pair of left and right shielded terminals 30 and the first and second shield shells 50 and 60 are electrically connected. Further, the shielding function of the connector 1 is improved by surrounding the shielded terminals 30 with the first shield shell 50 and the second shield shell 60.

### Operations and Effects

As described above, according to the connector 1 of the present embodiment, a conductive exterior member (the first shield shell 50 and the second shield shell 60) electrically connected to ground terminals (the shielded terminals 30) includes a first sheath portion (the sheath portions 54 and 61) covering one of the ground terminals (30, a first ground terminal), a second sheath portion (the sheath portions 54 and 61) covering the other one of the ground terminals (30, a second ground terminal), and a coupling portion (the coupling portions 55 and 62) disposed between the one ground terminal (30) and the other ground terminal (30) and connecting the first sheath portion (54 and 61) and the second sheath portion (54 and 61). Each of the first sheath portion (54 and 61) and the second sheath portion (54 and 61) has a protrusion portion (56 and 63) that protrudes toward the corresponding ground terminal (30) and is in contact with the corresponding ground terminal (30). Further, the coupling portion (55 and 62) has a shape bent to protrude toward the ground terminals (30) at connection portions (the protrusion portions 57 and 64 (first and second connection portions)) with the first sheath portion (54 and 61) and the second sheath portion (54 and 61), and the connection portions (57 and 64) are in contact with the ground terminals (30), respectively. Since the protrusion portions (56 and 63) and the connection portions (57 and 64) are in contact with the ground terminals (30), respectively, the ground terminals (30) and the exterior member (50 and 60) are electrically connected. In other words, the connection portions (57 and 64) between the coupling portion (55 and 62) and each of the first sheath portion (54 and 61) and the second sheath portion (54 and 61) have the same function as the protrusion portions (56 and 63) for the electrical connection. In addition, the coupling portion (55 and 62) also has a function of regulating (that is, partitioning) the positions of the pair of ground terminals (30) so that the ground terminals (30) maintain an appropriate interval. Therefore, even when the first shield shell 50 and the second shield shell 60 are molded by the pressing, it is not necessary to extremely largely deform the base materials thereof to enter the gap between the pair of ground terminals (30) in a wedge shape. Therefore, by connecting the first sheath portion (54 and 61) and the second sheath portion (54 and 61) via the coupling portion (55 and 62) having such a shape, the protrusion portions (56, 57, 63, and 64) provided on the first sheath portion (54 and 61) and the second sheath portion (54 and 61) are appropriately molded. Accordingly, the reliability of the electrical connection between the exterior member (50 and 60) and the ground terminals (30) is enhanced, and thus the shielding function of the connector 1 is improved. Therefore, the connector 1 according to the present embodiment is excellent in the shielding function.

Further, according to the connector 1 of the present embodiment, in the coupling portion (55 and 62) of the exterior member (50 and 60), a portion sandwiched between one of the connection portions (57 and 64) and the other one of the connection portions (57 and 64) does not have a shape protruding in a direction of entering the gap between the one ground terminal (30) and the other ground terminal (30). That is, the portion sandwiched between the one connection portion (57 and 64) and the other connection portion (57 and 64) has a shape protruding in a direction away from the gap, or a flat shape that is not a convex shape. Accordingly, the excessive extension of the base material at the time of molding can be further restrained.

Further, according to the connector 1 of the present embodiment, the exterior member includes a first exterior member (the first shield shell 50) and a second exterior member (the second shield shell 60) that are disposed to sandwich the ground terminals (30), and are electrically connected to the ground terminals (30). Accordingly, the shielding function of the connector 1 is further improved by surrounding the ground terminals (30) with the first exterior member (the first shield shell 50) and the second exterior member (the second shield shell 60).

Further, according to the connector 1 of the present embodiment, the first exterior member (50) and the second exterior member (60) are fastened to each other to sandwich the ground terminals (30). Accordingly, the protrusion portions (56 and 63) and the connection portions (57 and 64) of the exterior member (50 and 60) are pressed against the ground terminals (30) in accordance with the fastening, the reliability of the electrical connection between the exterior member (50 and 60) and the ground terminals (30) is further enhanced, and thus the shielding function of the connector 1 is further improved.

### Other Embodiments

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of the components in the embodiment described above are freely selected and are not limited as long as the present disclosure can be implemented.

In the above embodiment, in each of the first shield shell 50 and the second shield shell 60, the coupling portion (55 and 62) has a shape bent to protrude toward the ground terminals (30) at the connection portion (57 and 64) between the coupling portion (55 and 62) and the first sheath portion (54 and 61) and at the connection portion (57 and 64) between the coupling portion (55 and 62) and the second sheath portion (54 and 61), and the connection portions (57 and 64) are in contact with the ground terminals (30), respectively. In contrast, only one of the first shield shell 50 and the second shield shell 60 may be configured as described above.

Here, features of the embodiment of the connector 1 according to the present disclosure described above are briefly summarized and listed in the following [1] to [4].

[1] A connector (1) includes

a pair of electric wires (10) each including a conductor core wire (11) and a shield material (13) covering the conductor core wire (11),

a pair of energizing terminals (20) electrically connected to the conductor core wires (11), respectively;

a pair of ground terminals (30) electrically connected to the shield materials (13), respectively;

a housing (40) in which the pair of energizing terminals (20) are accommodated; and

a conductive exterior member (50 and 60) electrically connected to the pair of ground terminals (30), in which

the exterior member (50 and 60) includes

a first sheath portion (54 and 61) disposed to cover a first ground terminal of the pair of ground terminals (30),

a second sheath portion (54 and 61) disposed to cover a second ground terminal of the pair of ground terminals (30), and

a coupling portion (55 and 62) disposed between the first ground terminal (30) and the second ground terminal (30) and connecting the first sheath portion (54 and 61) and the second sheath portion (54 and 61),

the first sheath portion (54 and 61) includes a protrusion portion (56 and 63) protruding toward the first ground terminal (30) and being in contact with the first ground terminal (30),

the second sheath portion (54 and 61) includes a protrusion portion (56 and 63) protruding toward the second ground terminal (30) and being in contact with the second ground terminal (30), and

the coupling portion (55 and 62) has a shape bent to protrude toward the pair of ground terminals (30) at a first connection portion (57 and 64) between the coupling portion (55 and 62) and the first sheath portion (54 and 61) and at a second connection portion (57 and 64) between the coupling portion (55 and 62) and the second sheath portion (54 and 61), and the first and second connection portions (57 and 64) are in contact with the pair of ground terminals (30), respectively.

According to the connector having the configuration of [1] above, the conductive exterior member (for example, an upper shell and a lower shell constituting the shield shell) electrically connected to the ground terminals includes the first sheath portion covering the first ground terminal, the second sheath portion covering the second ground terminal, and the coupling portion disposed between the first ground terminal and the second ground terminal and connecting the first sheath portion and the second sheath portion. Each of the first sheath portion and the second sheath portion includes the protrusion portion that protrudes toward the corresponding ground terminal and is in contact with the corresponding ground terminal. Further, the coupling portion has a shape bent to protrude toward the ground terminals at the connection portions with the first sheath portion and the second sheath portion, and the connection portions are in contact with the ground terminals, respectively. Since the protrusion portions and the connection portions are in contact with the ground terminals, respectively, the ground terminals and the exterior member are electrically connected. In other words, the connection portions between the coupling portion and each of the first sheath portion and the second sheath portion have the same function as the protrusion portions for the electrical connection. In addition, the coupling portion also has a function of regulating (that is, partitioning) the positions of the pair of ground terminals so that the ground terminals maintain an appropriate interval. Therefore, even when the exterior member is molded by the pressing, it is not necessary to extremely largely deform the base material of the exterior member to enter the gap between the pair of ground terminals in the wedge shape. Therefore, by connecting the first sheath portion and the second sheath portion via the coupling portion having such a shape, the protrusion portions provided on the first sheath portion and the second sheath portion are appropriately molded. Accordingly, the reliability of the electrical connection between the exterior member and the ground terminals is enhanced, and thus the shielding function of the connector is improved. Therefore, the connector having this configuration is excellent in the shielding function.

[2] In the connector (1) according to [1] above,

in the coupling portion (55 and 62),

a portion sandwiched between the first connection portions (57 and 64) and the second connection portions (57 and 64) does not have a shape protruding in a direction of entering a gap between the first ground terminal (30) and the second ground terminal (30).

According to the connector having the configuration of [2] above, in the coupling portion of the exterior member, the portion sandwiched between the one connection portion and the other connection portion does not have a shape protruding in the direction of entering the gap between the first ground terminal and the second ground terminal. That is, the portion sandwiched between the one connection portion and the other connection portion has a shape protruding in the direction away from the gap, or a flat shape that is not a convex shape. Accordingly, the excessive extension of the base material at the time of molding can be further restrained.

[3] In the connector (1) according to [1] above,

the exterior member includes a first exterior member (50) and a second exterior member (60) that are disposed to sandwich the pair of ground terminals (30), and are electrically connected to the pair of ground terminals (30).

According to the connector having the configuration of [3] above, the exterior member includes the first exterior member and the second exterior member that are disposed to sandwich the ground terminals and are electrically connected to the ground terminals. Accordingly, the shielding function of the connector is further improved by surrounding the ground terminals with the first exterior member and the second exterior member.

[4] In the connector (1) according to [3] above,

the first exterior member (50) and the second exterior member (60) are fastened to each other to sandwich the pair of ground terminals (30).

According to the connector having the configuration of [4] above, the first exterior member and the second exterior member are fastened to each other to sandwich the ground terminals. Accordingly, the protrusion portions and the connection portions of the exterior member are pressed against the ground terminals in accordance with the fastening, the reliability of the electrical connection between the exterior member and the ground terminals is further enhanced, and thus the shielding function of the connector is further improved.

What is claimed is:

1. A connector comprising:
a pair of electric wires each including a conductor core wire and a shield material covering the conductor core wire;
a pair of energizing terminals electrically connected to the conductor core wires, respectively;
a pair of ground terminals electrically connected to the shield materials, respectively;
a housing in which the pair of energizing terminals are accommodated; and
a conductive exterior member electrically connected to the pair of ground terminals, wherein
the exterior member includes
a first sheath portion disposed to cover a first ground terminal of the pair of ground terminals,
a second sheath portion disposed to cover a second ground terminal of the pair of ground terminals, and
a coupling portion disposed between the first ground terminal and the second ground terminal and connecting the first sheath portion and the second sheath portion,
the first sheath portion includes a protrusion portion protruding toward the first ground terminal and being in contact with the first ground terminal,
the second sheath portion includes a protrusion portion protruding toward the second ground terminal and being in contact with the second ground terminal, and
the coupling portion has a bent shape protruding toward the pair of ground terminals at a first connection portion between the coupling portion and the first sheath portion and at a second connection portion between the coupling portion and the second sheath portion, and the first and second connection portions are in contact with the pair of ground terminals, respectively.

2. The connector according to claim 1, wherein
in the coupling portion,
a portion sandwiched between the first connection portion and the second connection portion does not have a shape protruding in a direction of entering a gap between the first ground terminal and the second ground terminal.

3. The connector according to claim 1, wherein
the exterior member includes a first exterior member and a second exterior member that are disposed to sandwich the pair of ground terminals, and are electrically connected to the pair of ground terminals.

4. The connector according to claim 3, wherein
the first exterior member and the second exterior member are fastened to each other to sandwich the pair of ground terminals.
